(19) United States
(12) Patent Application Publication
(10) Pub. No.: US 2004/0029091 A1
(43) Pub. Date: Feb. 12, 2004

(54) Clock - learning aid and combination

(76) Inventor: Marat Gitman, (US)

Correspondence Address: MARAT GITMAN, 230 Penn Lane, Rochester, NY, 14625, US

(21) Appl. No.: 10/613,947

(22) Filed: Jul. 7, 2003

Related U.S. Application Data
(60) Provisional application No. 60/393,761, filed on Jul. 8, 2002.

(51) Int. Cl. G09B 19/12

(52) U.S. Cl. 434/304

(57) ABSTRACT

Clock-learning aid combination is a truly unique solution for children of all ages and anybody else who wishes to enhance their skill of learning vocabulary and other subjects.

The purpose of this invention is to present educational materials adjacent to an object that displays time, which is frequently looked at throughout the day.

It is a combination of a clock and a display of thesaurus (or other learning materials, e.g., vocabulary, historical facts, spelling). The vocabulary/thesaurus display shows one word at a time with its thesaurus. The display is of such size that it is visible from anywhere within an average room.

The content can be arranged according to different linguistic levels, to suit various ages, and topics. The content can be loaded via a cartridge and updated as needed. The learning material display item will appear at a rate selected by the user (e.g. one word per hour).

### CROSS REFERENCE TO RELATED APPLICATIONS

This application is based on provisional application serial No. 60/393,761, filed on Jul. 8, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of electronic dictionaries and more specifically to Clock - Learning aid Combination.

Dictionaries have always been a valuable part of children's education both at home and in school. The way young students collect new vocabulary words is going to reflect upon their future academic and career endeavors. The more a person reads the more he or she will look up new words in the dictionary. Memory research claims that a person can memorize three to four words at one time. Out of these words only one or two at the most will remain in long-term memory. For that reason we can conclude that children as well as adults who use dictionaries quite often will have a much larger vocabulary than any other person. Even though we can remember only a particular amount of words, one can see how important vocabulary and knowledge of words is.

For one who is conscientious about his/her education and erudition would benefit a great deal using an electronic dictionary. When there is lack of time or even physical space to store multivolume dictionaries, an electronic one can be irreplaceable in our hectic lives. It can also be of great help to students of all ages. Reading a book or writing a paper a pupil will not only increase his/her vocabulary, but will show sophistication in writing and a greater understanding in reading.

Electronic dictionary is one of the modern possibilities of a dictionary. General principle of an electronic dictionary is described by Levy, Michael in U.S. Pat. No. 4,158,236 (1979). In the early 1990s computer technology made possible the release of dictionaries on floppy disks or CD-ROM, e.g., the electronic edition of The Random House Unabridged Dictionary (1993). Electronic dictionaries also became available as part of multivolume reference-book packages, such as Microsoft's Bookshelf CD-ROM, and as a feature of on-line services. Computer technology provided new ways to search for and link words and new ways to illustrate them, e.g., prerecorded pronunciations that users can play back. By the end of the 1990s many dictionaries were available in various print and electronic editions; the new Encarta World English Dictionary (1999) was released both as a printed book and a CD-ROM.

Dictionaries (books or electronic) are designed to provide reference upon need. Once a person needs to understand a word in one's reading he/she will try to find the word in a dictionary. However, one would not often read dictionary with a sole purpose of building up one's vocabulary Not only it consumes time, it also requires motivation. It is especially difficult with children. Parents who try to push their children to learn new vocabulary words and look up meanings in the dictionary, face great challenges with any type of dictionary, whether it is a volume or an electronic one.

The device that we offer would be a great help for the individuals who lack time or motivation. A clock that has vocabulary or other learning material display is a great finding for these people. Since clock is an article that people look at numerous times a day they are forced in a way to learn new words. These new words accumulate with time and most individuals, children including, are not even going to be aware of their learning process.

This is also true for other important information that requires memorization process. These include historical events, foreign languages words, thesaurus, and many others.

### BRIEF SUMMARY OF THE INVENTION

The primary object of the invention is to provide a convenient, no-time-consuming way for children and adults to enhance their vocabulary and/or knowledge in other subject areas that require memorization.

Let's assume that the clock's vocabulary / thesaurus display is set up to change words once per hour. This setting can produce up to sixteen impressions a day (to take into consideration that the child is not in his/her room all the time and is asleep at nighttime). If the child memorizes even one word per day (a low estimate), he/she will learn 356 words a year and 3560 words in ten years. Remember, these are complicated terms, not words of everyday language. Few adults can boast with such a rich vocabulary.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Clock-Learning aid Combination comprising: a. a devise to display learning material (for example, thesaurus, geographical terms, meanings of words, spelling, historic events and names), b. clock to display time and date, c. means to supply power, whereby educational materials displayed adjacent to display of time will be frequently looked at throughout the day. This fact will enhance memorization of the learning material.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the font of the invention.

FIG. 2 is a perspective view of the back of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

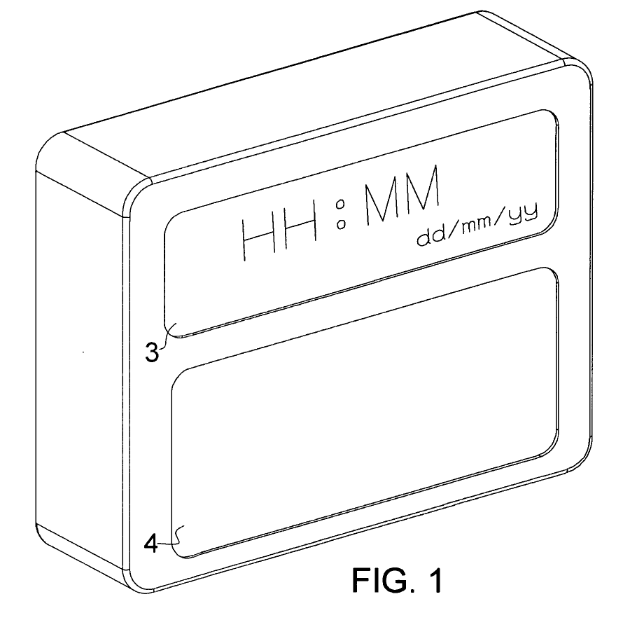

FIG. 1 is a perspective view of the front of the invention. It shows a clock display (3) and a display for learning material (4) (for example, thesaurus). The learning material display shows one word at a time with its array of thesaurus. The display is of such size that it is visible from anywhere within an average room.

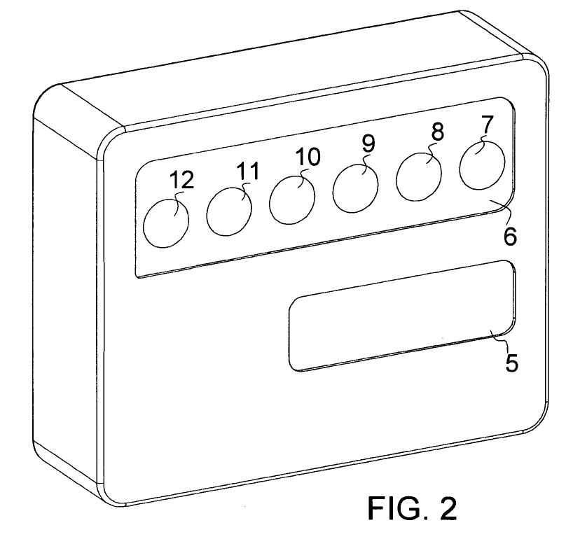

FIG. 2 is a perspective view of the back of the invention. It shows battery compartment (5) and control panel (6) The content of the learning material display (4) can be arranged according to different linguistic levels, to suit various ages, interests, and topics. The adjustment can be made by manipulating settings through the level adjustment button (7). The learning material item shall appear on its display at a rate selected by the user (e.g. one word per hour). The adjustment can be made by manipulating settings through the rate adjustment button (8). The buttons (9), (10), and (11) are to be used to manipulate date, hours and minutes on the clock display. The button (12) are to be used to enter/exit settings mode.

The clock can be mounted on a wall or used as a table-top clock.

Reference Numerals:

3.) Clock display

4.) Learning material display

5.) Battery compartment

6.) Settings panel

7.) Complexity level adjustment button

8.) Material iteration rate adjustment button

9.) Date adjustment button

10.) Hour adjustment button

11.) Minute adjustment button

12.) Exit/Enter settings mode button

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Clock-Learning aid Combination comprising:
a. a devise to display learning material (for example, thesaurus, geographical terms, meanings of words, spelling, historic events and names);
b. clock to display time and date;
c. means to supply power,
whereby educational materials displayed adjacent to display of time will be frequently looked at throughout the day. This fact will enhance memorization of the learning material.
